(19) United States
(12) Patent Application Publication
(10) Pub. No.: US 2023/0095055 A1
(43) Pub. Date: Mar. 30, 2023

(54) CONTROL DEVICE

(71) Applicant: FANUC CORPORATION, Minamitsuru-gun, Yamanashi (JP)

(72) Inventor: Kazuhiro YAMAMOTO, Yamanashi (JP)

(21) Appl. No.: 17/801,032

(22) PCT Filed: Mar. 1, 2021
(86) PCT No.: PCT/JP2021/007733

§ 371 Date: Aug. 19, 2022

(30) Foreign Application Priority Data
Mar. 6, 2020 (JP) 2020-038705

(51) Int. Cl. G05B 23/02

(52) U.S. Cl. CPC G05B 23/0221; G05B 23/027; G05B 23/0272

(57) ABSTRACT

The objective of the present invention is to acquire maintenance information easily when an alarm is generated. This control device for controlling an industrial machine is provided with: a monitoring unit which monitors the industrial machine to detect an abnormality in the industrial machine; an information acquiring unit which acquires alarm information relating to an alarm pertaining to the abnormality detected by the monitoring unit, and maintenance information relating to maintenance for dealing with the abnormality; and a display control unit which causes the acquired alarm information and maintenance information to be displayed on a display device.

### TECHNICAL FIELD

The present invention relates to a control device.

### BACKGROUND ART

A control device that controls an industrial machine such as a machine tool or a robot issue, in a case where anomaly such as breakdown has occurred in, e.g., the industrial machine or the control device, an alarm for notifying the anomaly and displays an alarm message on a display device, such as a liquid crystal display, in the control device. In this case, a worker needs to check the alarm message (e.g., an alarm number), search alarm contents from a maintenance instruction, and check the steps of performing maintenance. This process takes time and effort, and the worker needs to understand the maintenance steps from texts and images in the maintenance instruction. This leads to poor workability.

On this point, a technology is known in which measurement data indicating an operation state of a machine tool is checked against an anomaly detection condition and anomaly handling information such as the cause of an anomaly, the location of occurrence of the anomaly, and the method for handling the anomaly is displayed in a case where the anomaly detection condition is satisfied, i.e., it is determined that the anomaly will occur sometime in the near future. See Patent Document 1, for example.
Patent Document 1: Japanese Unexamined Patent Application, Publication No. 2003-280707

### DISCLOSURE OF THE INVENTION

### Problems to be Solved by the Invention

However, it is difficult to fully detect the anomaly even by the technique of checking the measurement data against the anomaly detection condition. Even if the anomaly detection condition is updated to enhance a detection accuracy, it is necessary to examine the cause of the occurred anomaly. This process takes time and effort.

In a case where an alarm has been issued without the anomaly detected, it still takes time to search maintenance steps to cancel the alarm. This process causes a problem that it takes time until operation is resumed. Even after the maintenance steps have been found, these maintenance steps are difficult to be understood in some cases. In some cases, maintenance information varies due to a change in mounted equipment (specifications or a version number) due to previous maintenance or retrofitting. In a case where there are no parts for maintenance in stock, the parts need to be ordered. However, there is also a problem that it takes time until the parts are obtained.

For these reasons, there has been a demand for easy acquisition of the maintenance information in a case where the alarm has been issued.

### Means for Solving the Problems

One aspect of the control device of the present disclosure is a control device for controlling an industrial machine, the control device including a monitoring unit configured to monitor the industrial machine to sense anomaly in the industrial machine, an information acquisition unit configured to acquire alarm information regarding an alarm of the anomaly sensed by the monitoring unit and maintenance information regarding maintenance in response to the anomaly, and a display control unit configured to display the acquired alarm information and the acquired maintenance information on a display device.

### Effects of the Invention

According to one aspect, the maintenance information can be easily obtained in a case where the alarm has been issued.

### BRIEF DESCRIPTION OF THE DRAWINGS

FIG. 1 is a functional block diagram showing a functional configuration example of a control system according to a first embodiment;

FIG. 2 is a view showing one example of a screen on which an alarm, alarm information, and maintenance information are displayed;

FIG. 3 is a view showing one example of a screen on which the URL and two-dimensional code for the maintenance information are displayed together with the alarm information;

FIG. 4 is a flowchart for describing alarm processing of a numerical control device;

FIG. 5 is a functional block diagram showing a functional configuration example of a control system according to a second embodiment; and

FIG. 6 is a flowchart for describing alarm processing of a numerical control device.

### PREFERRED MODE FOR CARRYING OUT THE INVENTION

Hereinafter, a first embodiment of the present disclosure will be described using the drawings. In this embodiment, a machine tool will be described as an example of an industrial machine, and a numerical control device will be described as an example of a control device. Note that the present invention is not limited to the machine tool and is also applicable to an industrial robot, a service robot, etc.

### First Embodiment

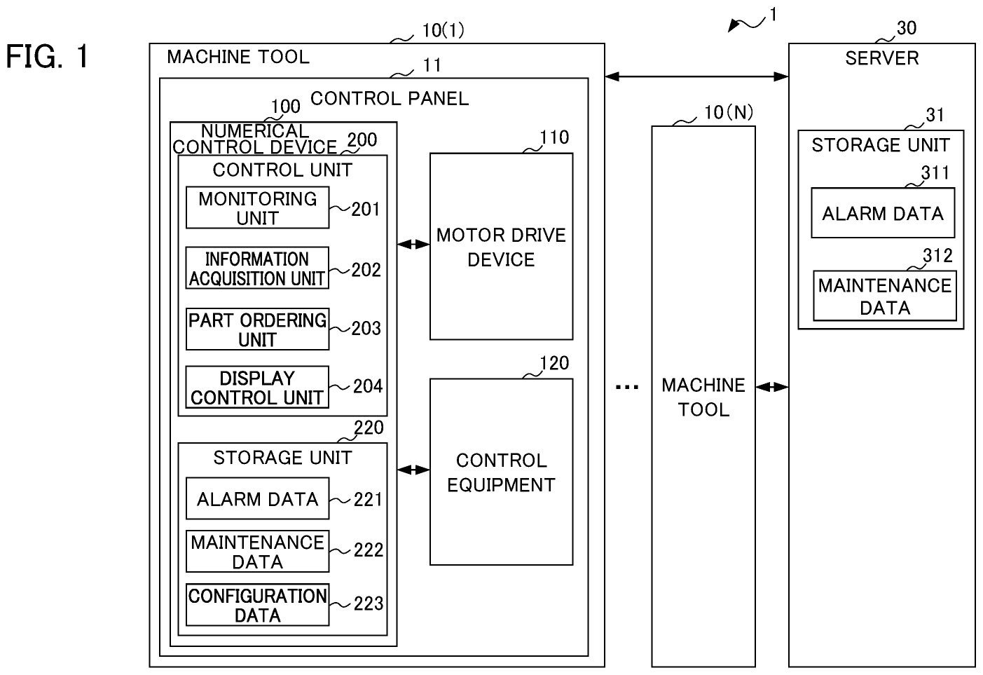

FIG. 1 is a functional block diagram showing a functional configuration example of a control system according to the first embodiment. As shown in FIG. 1, the control system 1 has N machine tools 10(1) to 10(N) and a server 30 (N is an integer of 1 or greater).

The machine tools 10(1) to 10(N) and the server 30 may be connected to each other via a not-shown network such as a local area network (LAN) or the Internet (N is an integer of 1 or greater). In this case, the machine tools 10(1) to 10(N) and the server 30 include not-shown communication units for communication thereamong by the above-described connection. Alternatively, the machine tools 10(1) to 10(N) and the server 30 may be directly connected to each other via a not-shown connection interface.

The server 30 is, for example, a computer device, and communicates with each of the machine tools 10(1) to 10(N) via the not-shown network. As shown in FIG. 1, the server 30 has a storage unit 31. As described later, the server 30 transmits alarm data 311 and/or maintenance data 312 stored in the storage unit 31 based on a request from each of the machine tools 10(1) to 10(N) via the not-shown network.

The storage unit 31 includes, for example, a solid state drive (SSD) and a hard disk drive (HDD). The storage unit 31 stores the alarm data 311 and the maintenance data 312 together with a control program and an operating system (OS) to be executed by a control unit (not shown) that controls operation of the server 30.

The alarm data 311 includes alarm information indicating occurrence of anomaly such as breakdown and including an alarm number, an alarm name, and alarm contents for each component, such as a numerical control device and a motor drive device, forming each of the later-described machine tools 10(1) to 10(N).

The maintenance data 312 includes, for example, text data, a static image, and a moving image for describing maintenance process steps for each piece of the alarm information in the alarm data 311.

Alternatively, the maintenance data 312 may include the uniform resource locator (URL) of a maintenance website of, e.g., a machine tool builder or a parts manufacturer for providing the maintenance process steps for each piece of the alarm information in the alarm data 311. Alternatively, the maintenance data 312 may include a two-dimensional code with the URL of the maintenance website.

Note that in a case where the specifications and/or the version number of the component such as the numerical control device or the motor drive device have been updated, the latest alarm information and the latest maintenance information on the updated component may be added as needed to the alarm data 311 and the maintenance data 312 in the server 30.

### <Machine Tools 10(1) to 10(N)>

The machine tools 10(1) to 10(N) are machine tools well-known by those skilled in the art, and operate based on an operation command from the later-described numerical control device 100 as the control device.

As shown in FIG. 1, the machine tool 10(1) has a control panel 11. The control panel 11 has the numerical control device 100, the motor drive device 110, and control equipment 120. The numerical control device 100 has a control unit 200 and a storage unit 220. The control unit 200 has a monitoring unit 201, an information acquisition unit 202, a part ordering unit 203, and a display control unit 204.

Hereinafter, the machine tool 10(1) will be described, and the machine tools 10(2) to 10(N) include at least numerical control devices 100 having a function equivalent to that of the machine tool 10(1) and may include components identical to or different from those of the machine tool 10(1) other than the numerical control devices 100. Moreover, the machine tools 10(1) to 10(N) may be arranged at the same factory or different factories.

The motor drive device 110 drivably controls, e.g., a servomotor of a not-shown mechanism of the machine tool 10(1) via a not-shown servo amplifier based on the operation command from the later-described numerical control device 100.

The control equipment 120 is equipment that controls a programmable logic controller (PLC) to be operated based on the operation command from the later-described numerical control device 100 and peripheral equipment such as a cutting fluid pump.

### <Numerical Control Device 100>

The numerical control device 100 is a numerical control device well-known by those skilled in the art, and generates the operation command based on a machining program acquired from an external device (not shown) such as a CAD/CAM device and transmits the generated operation command to the motor drive device 110 and the control equipment 120. With this configuration, the numerical control device 100 drives the not-shown mechanism of the machine tool 10(1). Note that in a case where the machine tool 10(1) is a robot, the numerical control device 100 may be a robot control device, for example.

### <Storage Unit 220>

The storage unit 220 includes, for example, a random access memory (PAM) and a HDD. The storage unit 220 stores alarm data 221, maintenance data 222, and configuration data 223.

The alarm data 221 includes alarm information indicating occurrence of failure such as breakdown and including an alarm number, an alarm name, and alarm contents according to the component, such as the numerical control device 100 or the motor drive device 110, forming the machine tool 10(1). Note that the alarm data 221 may be stored in advance in the storage unit 220 at the time of manufacturing the machine tool 10(1) or may be downloaded from the server 30 via the not-shown network, for example.

The maintenance data 222 includes, for example, text data, a static image, and a moving image for describing maintenance process steps for each piece of the alarm information in the alarm data 221.

Alternatively, the maintenance data 222 may include the URL of a maintenance website of, e.g., a machine tool builder or a parts manufacturer for providing the maintenance process steps for each piece of the alarm information in the alarm data 221. Alternatively, the maintenance data 222 may include a two-dimensional code with the URL of the maintenance website.

Note that the maintenance data 222 may be stored in advance in the storage unit 220 at the time of manufacturing the machine tool 10(1) or may be downloaded from the server 30 via the not-shown network, for example.

The configuration data 223 includes identification information for identifying each component, such as the numerical control device 100, the motor drive device 110, the control equipment 120, and the not-shown mechanism, forming the machine tool 10(1) and configuration information such as a setting.

### <Control Unit 200>

The control unit 200 is well-known by those skilled in the art, the control unit 200 having, for example, a central processing unit (CPU), a read only memory (ROM), a RAM, and a complementary metal-oxide-semiconductor (CMOS) memory such that these components are communicable with each other via a bus.

The CPU is a processor that controls the numerical control device 100 as a whole. The CPU reads a system program and an application program from the ROM via the bus, and controls the entirety of the numerical control device 100 according to the system program and the application program. With this configuration, the control unit 200 implements the functions of the monitoring unit 201, the information acquisition unit 202, the part ordering unit 203, and the display control unit 204, as shown in FIG. 1. The RAM temporarily stores various types of data such as calculation data and display data. The CMOS memory is configured as a non-volatile memory backed up by a not-shown battery and holding a storage state even when the numerical control device 100 is powered off.

The monitoring unit 201 monitors operation states of the numerical control device 100, the motor drive device 110, the control equipment 120, and the not-shown mechanism of the machine tool 10(1).

Specifically, the monitoring unit 201 monitors the presence or absence of an error in the numerical control device 100, and monitors the presence or absence of anomaly, such as breakdown or motor overload, in the not-shown mechanism via the motor drive device 110, for example. Alternatively, the monitoring unit 201 may acquire measurement data from various sensors, such as an acceleration sensor and a temperature sensor, arranged in the machine tool 10(1), thereby monitoring the operation states of the numerical control device 100, the motor drive device 110, the control equipment 120, and the not-shown mechanism of the machine tool 10(1) based on the acquired measurement data.

The monitoring unit 201 senses occurrence of the error in the numerical control device 100 or the anomaly such as the motor overload. Specifically, the monitoring unit 201 senses the component in which the anomaly has occurred, and acquires the identification information on the component in which the anomaly has occurred from the configuration data 223. The monitoring unit 201 outputs, e.g., the acquired identification information and monitoring information to the information acquisition unit 202.

The information acquisition unit 202 acquires the alarm information from the alarm data 221 based on, e.g., the identification information and the monitoring information on the component in which the anomaly has occurred after having received such information from the monitoring unit 201.

Moreover, the information acquisition unit 202 acquires the maintenance information regarding maintenance in response to the alarm from the maintenance data 222 based on, e.g., the identification information and the monitoring information on the component in which the anomaly has occurred. The information acquisition unit 202 outputs the acquired alarm information and the acquired maintenance information to the later-described display control unit 204 such that the acquired alarm information and the acquired maintenance information are displayed on a display device (not shown), such as a liquid crystal display, in the numerical control device 100.

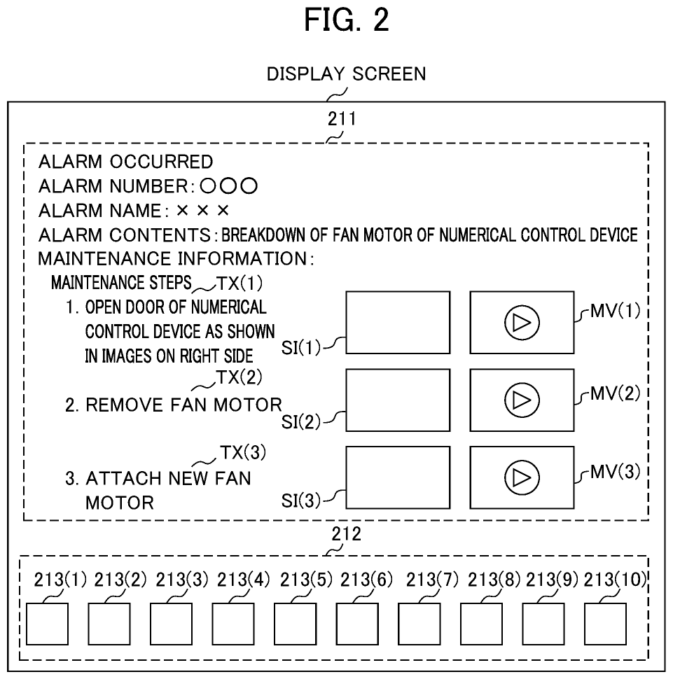

FIG. 2 is a view showing one example of a screen on which the alarm, the alarm information, and the maintenance information are displayed.

As shown in FIG. 2, the display screen has, for example, an information display area 211 where the alarm, the alarm information, and the maintenance information are displayed and a softkey display area 212 where softkeys 213(1) to 213(10) are displayed.

Specifically, in a case where a fan motor of the numerical control device 100 has been broken down, the alarm number, the alarm name, and the alarm contents are displayed as the alarm information on the information display area 211, for example. Moreover, texts TX(1) to TX(3), static images SI(1) to SI(3), and moving images MV(1) to MV(3) for describing the maintenance steps are displayed as the maintenance information on the information display area 211.

Note that the moving images MV(1) to MV(3) may be, for example, played or stopped in such a manner that a worker presses any of the softkeys 213(1) to 213(10) set as a play/stop key, for example.

The moving images MV(1) to MV(3) are played so that the worker can easily understand how to replace where and which component.

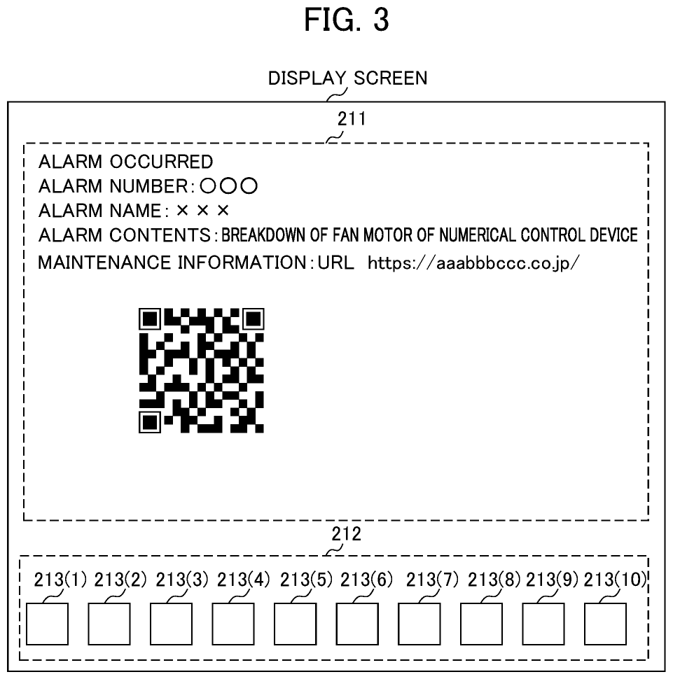

As shown in FIG. 3, the URL of the maintenance website for providing the maintenance process steps and/or the two-dimensional code may be displayed on the information display area 211 instead of the texts TX(1) to TX(3), the static images SI(1) to SI(3), and the moving images MV(1) to MV(3).

With this configuration, the worker inputs the URL to a terminal device such as a smartphone or a tablet terminal or reads the two-dimensional code with the terminal device so that the texts TX(1) to TX(3), the static images SI(1) to SI(3), and the moving images MV(1) to MV(3) for describing the maintenance process steps can be displayed on the terminal device, for example. Moreover, the worker can perform a maintenance process while viewing a display screen of the terminal device at a workplace.

Alternatively, the information acquisition unit 202 may acquire part information regarding a part necessary for maintenance from an inventory control system (not shown), that manages the inventory of the part, based on the acquired alarm information and the acquired maintenance information, for example. The information acquisition unit 202 may display the maintenance information including the acquired part information on the display device (not shown) of the numerical control device 100 via the later-described display control unit 204. With this configuration, the worker can check, for example, the inventory of the part necessary for maintenance.

Note that the part information may include at least a part name, a part model, a part manufacturer, a supplier, a part price, the required number of parts, and a delivery deadline. A well-known inventory control system may be utilized as the inventory control system, and detailed description thereof will be omitted.

The part ordering unit 203 outputs order information regarding a part order based on the part information acquired by the information acquisition unit 202.

Specifically, the part ordering unit 203 may automatically order the part based on the part information via the not-shown network in a case where the required number of parts for maintenance is in stock, for example. In a case where the order has been placed, the part ordering unit 203 may display the order information on the display device (not shown) of the numerical control device 100 via the later-described display control unit 204.

With this configuration, the worker views the display screen of the display device (not shown) of the numerical control device 100 so that the worker can check the information regarding the anomaly as a cause for the alarm and the maintenance steps and can check the status of the inventory of the part required and the order status.

The display control unit 204 displays the alarm information, the maintenance information, etc. shown in FIG. 2 or 3 on the display device (not shown) of the numerical control device 100.

### <Alarm Processing of Numerical Control Device 100>

Next, operation of the numerical control device 100 for alarm processing according to the first embodiment will be described.

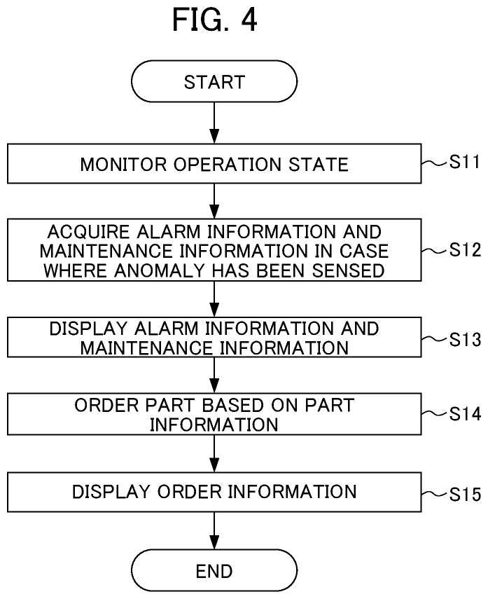

FIG. 4 is a flowchart for describing the alarm processing of the numerical control device 100.

In Step S11, the monitoring unit 201 monitors the operation states of the numerical control device 100, the motor drive device 110, the control equipment 120, the not-shown mechanism, etc. of the machine tool 10(1).

In a case where the monitoring unit 201 has sensed the anomaly in Step S11, the information acquisition unit 202 acquires, in Step S12, the alarm information and the maintenance information from the alarm data 221 and the maintenance data 222 based on the identification information, the monitoring information, etc. on the component in which the anomaly has occurred after having received such information from the monitoring unit 201.

In Step S13, the display control unit 204 displays the alarm information and the maintenance information acquired in Step S12 on the display device (not shown) of the numerical control device 100.

In Step S14, the part ordering unit 203 automatically orders the part based on the part information in the maintenance information acquired in Step S12.

In Step S15, the display control unit 204 displays the order information regarding the part ordered in Step S14 on the display device (not shown) of the numerical control device 100.

By the above-described steps, the numerical control device 100 according to the first embodiment monitors the operation states of the numerical control device 100, the motor drive device 110, the control equipment 120, the not-shown mechanism, etc. of the machine tool 10(1). In a case where the anomaly has been sensed, the numerical control device 100 acquires the alarm information and the maintenance information from the alarm data 221 and the maintenance data 222 based on the identification information, the monitoring information, etc. on the component in which the anomaly has occurred, and displays the alarm information and the maintenance information to notify the worker of such information. With this configuration, in a case where the anomaly has been sensed, the numerical control device 100 can easily obtain not only the alarm information but also the maintenance information, and can save the effort of searching a maintenance instruction or the maintenance steps. Thus, time until operation is resumed can be shortened.

Moreover, the numerical control device 100 automatically orders the part based on the part information in the maintenance information. With this configuration, the part can be obtained when needed without the need for always storing parts necessary for maintenance.

The first embodiment has been described above.

### Second Embodiment

Next, a second embodiment will be described. In the second embodiment, a numerical control device 100A further has, in addition to the functions of the first embodiment, the function of acquiring corresponding alarm information and corresponding maintenance information from an external device if the alarm information and the maintenance information are not stored in the numerical control device 100A in a case where mounted equipment has been updated and anomaly has been sensed in the updated equipment.

With this configuration, the numerical control device 100A of the second embodiment can display the alarm information and the maintenance information suitable for the actually-mounted equipment, and can cause a worker to perform a maintenance process.

Hereinafter, the second embodiment will be described.

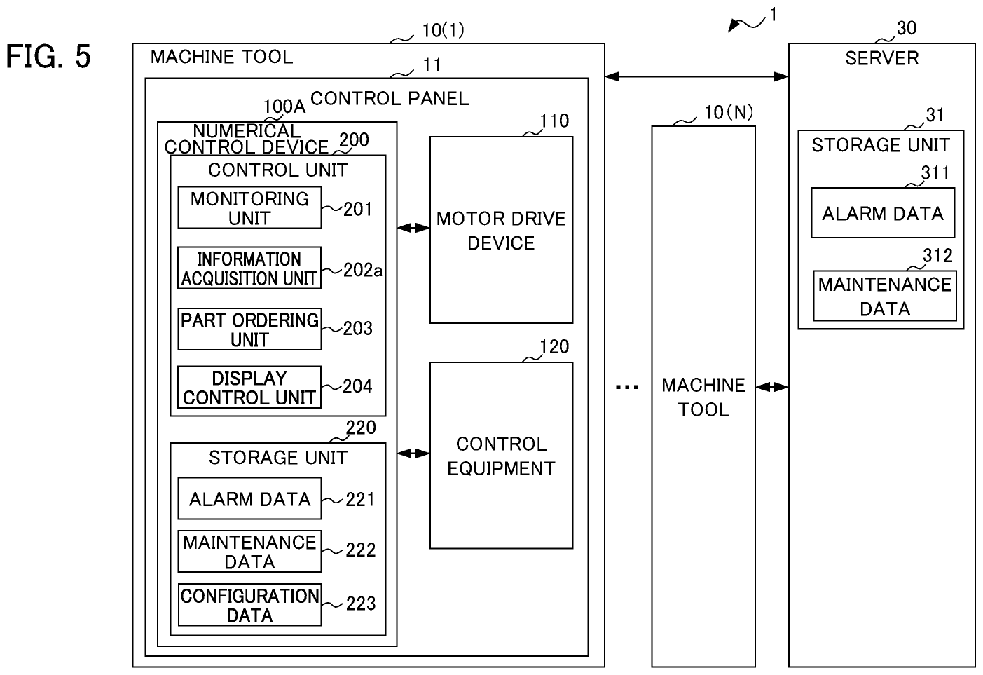

FIG. 5 is a functional block diagram showing a function configuration example of a control system according to the second embodiment. Note that the same reference numerals are used to represent elements having functions similar to those of the control system 1 of FIG. 1 and detailed description thereof will be omitted.

As shown in FIG. 5, the control system 1 according to the second embodiment has N machine tools 10(1) to 10(N) and a server 30.

### <Machine Tools 10(1) to 10(N))

The machine tools 10(1) to 10(N) according to the second embodiment have configurations similar to those of the machine tools 10(1) to 10(N) in the first embodiment.

That is, the machine tool 10(1) has a control panel 11 as shown in FIG. 5. The control panel 11 has the numerical control device 100A, a motor drive device 110, and control equipment 120. The numerical control device 100A has a control unit 200 and a storage unit 220. The control unit 200 has a monitoring unit 201, an information acquisition unit 202a, a part ordering unit 203, and a display control unit 204.

Hereinafter, the machine tool 10(1) will be described, and the machine tools 10(2) to 10(N) include numerical control devices 100A having a function similar to that of the machine tool 10(1) and may include components identical to or different from those of the machine tool 10(1) other than the numerical control devices 100A. Moreover, the machine tools 10(1) to 10(N) may be arranged at the same factory or different factories.

The motor drive device 110 and the control equipment 120 have functions equivalent to those of the motor drive device 110 and the control equipment 120 in the first embodiment.

The storage unit 220 has a function equivalent to that of the storage unit 220 in the first embodiment.

The monitoring unit 201, the part ordering unit 203, and the display control unit 204 have functions equivalent to those of the monitoring unit 201, the part ordering unit 203, and the display control unit 204 in the first embodiment.

The information acquisition unit 202a acquires, as in the information acquisition unit 202 of the first embodiment, the alarm information and the maintenance information on the component in which the anomaly has been sensed from alarm data 221 and maintenance data 222 based on identification information, monitoring information, etc. received from the monitoring unit 201.

At this point, in a case where a component of an old machine is retrofitted into a new model, the specifications of the component are changed in some cases. Examples of such a case may include cases where in the machine tool 10, the numerical control device 100A is changed from “Specifications AAA Version 01” to “Specifications aaa Version 01”, the motor drive device 110 is changed from “Specifications BBB Version 01” to “Specifications bbb Version 01”, and the control equipment 120 is changed from “Specifications CCC Version 01” to “Specifications ccc Version 01”.

In some cases, parts of the component are changed by hardware updating (a version number change) of the specifications of the component. Examples of such a case may include cases where in the machine tool 10, the numerical control device 100A is changed from “Specifications AAA Version 01” to “Specifications AAA Version 02”, the motor drive device 110 is changed from “Specifications BBB Version 01” to “Specifications BBB Version 02”, and the control equipment 120 is changed from “Specifications CCC Version 01” to “Specifications CCC Version 02”.

Note that in some cases, the alarm data 221 and the maintenance data 222 stored in the storage unit 220 of the numerical control device 100A are not updated even after the specifications and/or the version number of the component have been changed. Note that configuration data 223 constantly includes the latest identification information and the latest configuration information.

In this case, when the anomaly has been sensed in the component whose specifications and/or version number have been updated, the monitoring unit 201 outputs an identification information, the monitoring information, etc. corresponding to the updated component to the information acquisition unit 202a. However, in a case where the alarm data 221 and the maintenance data 222 are not updated, the information acquisition unit 202a sometimes cannot acquire the alarm information and the maintenance information corresponding to the updated component from the alarm data 221 and the maintenance data 222.

For this reason, in the above-described case, the information acquisition unit 202a according to the second embodiment acquires the alarm information and the maintenance information on the updated component in which the anomaly has been sensed from alarm data 311 and maintenance data 312 in the server 30 via a not-shown network.

Note that in a case where the specifications or the version number of the component have been updated, the numerical control device 100A may automatically download alarm data and maintenance data on the machine tool 10(1) among the alarm data 311 and the maintenance data 312 in the server 30 and may update the alarm data 221 and the maintenance data 222, for example.

### <Alarm Processing of Numerical Control Device 100A>

Next, operation of the numerical control device 100A for alarm processing according to the second embodiment will be described.

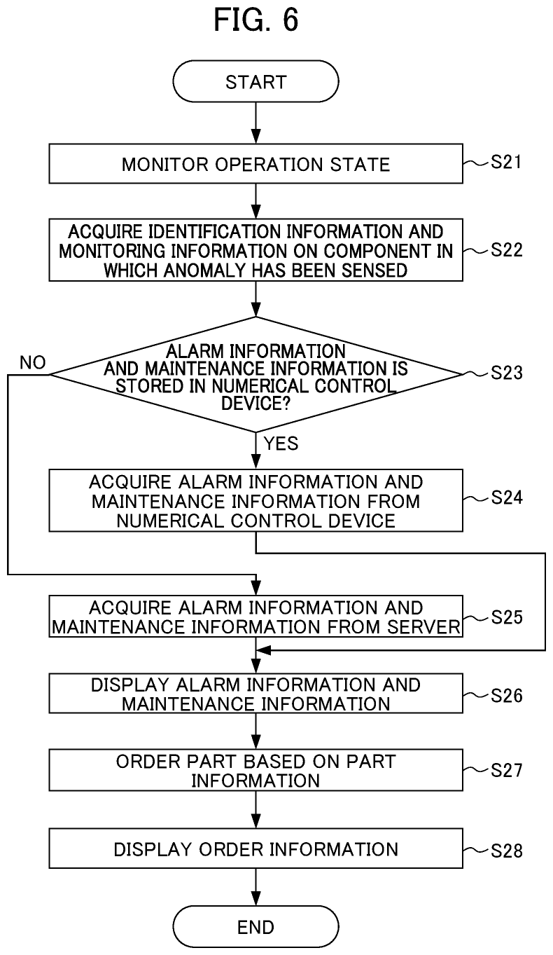

FIG. 6 is a flowchart for describing the alarm processing of the numerical control device 100A.

Note that in the alarm processing shown in FIG. 6, the processing of Step S21 and the processing from Step S26 to Step S28 are similar to that of Step S11 and that from Step S13 to Step S15 in FIG. 3 in the first embodiment, and description thereof will be omitted.

In a case where the anomaly has been sensed by the monitoring unit 201 in Step S21, the information acquisition unit 202a acquires, in Step S22, the identification information and the monitoring information on the component in which the anomaly has been sensed.

In Step S23, the information acquisition unit 202a determines whether or not the alarm information and the maintenance information, which have been acquired in Step S22, on the component in which the anomaly has been sensed are stored in the numerical control device 100A. In a case where the alarm information and the maintenance information are stored in the alarm data 221 and the maintenance data 222 in the numerical control device 100A, the processing proceeds to Step S24. On the other hand, in a case where the alarm information and the maintenance information are not stored in the alarm data 221 and the maintenance data 222 in the numerical control device 100A, the processing proceeds to Step S25.

In Step S24, the information acquisition unit 202a acquires the alarm information and the maintenance information from the alarm data 221 and the maintenance data 222 in the numerical control device 100A.

In Step S25, the information acquisition unit 202a acquires the alarm information and the maintenance information from the alarm data 311 and the maintenance data 312 in the server 30.

By the above-described steps, the numerical control device 100A according to the second embodiment monitors operation states of the components such as the numerical control device 100A, the motor drive device 110, the control equipment 120, a not-shown mechanism, etc. of the machine tool 10(1). In a case where the anomaly has been sensed, the numerical control device 100A determines whether or not the alarm information and the maintenance information corresponding to the component in which the anomaly has been sensed are stored in the alarm data 221 and the maintenance data 222 in the numerical control device 100A. In a case where the alarm information and the maintenance information corresponding to the component in which the anomaly has been sensed are not stored in the alarm data 221 and the maintenance data 222 in the numerical control device 100A, the numerical control device 100A acquires the alarm information and the maintenance information from the alarm data 311 and the maintenance data 312 in the server 30. The numerical control device 100A displays the alarm information and the maintenance information, thereby notifying the worker of such information.

With this configuration, in a case where the anomaly has been sensed, the numerical control device 100A can easily obtain not only the alarm information but also the maintenance information, and can save the effort of searching for a maintenance instruction or maintenance steps. Thus, time until operation is resumed can be shortened. Moreover, the maintenance information suitable for the actually-mounted component is displayed so that the worker can accurately perform a maintenance process.

Further, the numerical control device 100A automatically orders a part based on part information in the maintenance information. With this configuration, the part can be obtained when needed without the need for always storing parts necessary for maintenance.

The second embodiment has been described above.

The first embodiment and the second embodiment have been described above, but the numerical control devices 100, 100A are not limited to those in the above-described embodiments and variations, modifications, etc. are included within such a scope that the object can be achieved.

### <Variation 1>

The monitoring unit 201, the information acquisition unit 202, and the part ordering unit 203 are included in the numerical control device 100 in the above-described first embodiment, and the monitoring unit 201, the information acquisition unit 202a, and the part ordering unit 203 are included in the numerical control device 100A in the second embodiment. However, the present invention is not limited to above. For example, some or all of the monitoring unit 201, the information acquisition unit 202 (202a), and the part ordering unit 203 may be included in, e.g., the motor drive device 110 or the control equipment 120.

### <Variation 2>

For example, in the first embodiment and the second embodiment, the information acquisition unit 202, 202a outputs the part information to the part ordering unit 203, and the part ordering unit 203 automatically orders the part based on the part information. However, the present invention is not limited to above. For example, the information acquisition unit 202, 202a may output the part information to a display device, such as a liquid crystal display, of a personal computer of a person in charge of order. With this configuration, the person in charge can order the part based on the part information.

Note that each function of the numerical control devices 100, 100A in the first embodiment and the second embodiment may be implemented by hardware, software, or a combination thereof. Implementation by the software as described herein means that the function is implemented in such a manner that a computer reads and executes a program.

The program can be stored using various types of non-transitory computer readable media and be supplied to the computer. The non-transitory computer readable media include various types of tangible storage media. Examples of the non-transitory computer readable media include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PRPM), an erasable PROM (EPROM), a flash ROM, and a RAM). The program may be supplied to the computer by means of various types of transitory computer readable media. Examples of the transitory computer readable media include an electrical signal, an optical signal, and an electromagnetic wave. The transitory computer readable medium can supply the program to the computer via a wired communication path such as an electric wire or an optical fiber or a wireless communication path.

Steps of describing the program to be recorded on a recording medium include not only processes that are executed in time sequence according to the order, but also processes that are executed in parallel or individually and not necessarily in time sequence.

In other words, the control device of the present disclosure may include various embodiments having the following configurations.

(1) The numerical control device 100 of the present disclosure is the control device for controlling the machine tool 10(1), the control device including the monitoring unit 201 configured to monitor the machine tool 10(1) to sense anomaly in the machine tool 10(1), the information acquisition unit 202 configured to acquire the alarm information regarding the alarm of the anomaly sensed by the monitoring unit 201 and the maintenance information regarding maintenance in response to the anomaly, and the display control unit 204 configured to display the acquired alarm information and the acquired maintenance information on the display device.

According to the numerical control device 100, the maintenance information can be easily obtained in a case where the alarm has been issued.

(2) In the numerical control device 100 according to (1), the maintenance information may include at least the text information and the static image for describing the maintenance process steps.

With this configuration, the effort of searching for the maintenance instruction or the maintenance steps can be saved, and therefore, the time until operation is resumed can be shortened.

(3) In the numerical control device 100 according to (1) or (2), the maintenance information may include the URL of the maintenance website for describing the maintenance process steps.

With this configuration, the worker can perform the maintenance process while viewing the display screen of the terminal device such as a smartphone at the workplace.

(4) In the numerical control device 100 according to any one of (1) to (3), the maintenance information may include the two-dimensional code for the maintenance website for describing the maintenance process steps.

With this configuration, the worker can perform the maintenance process while viewing the display screen of the terminal device such as a smartphone at the workplace.

(5) In the numerical control device 100 according to any one of (1) to (4), the maintenance information may include the moving image for describing the maintenance process steps.

With this configuration, the worker can easily understand how to replace where and which component.

(6) In the numerical control device 100 according to any one of (1) to (5), the maintenance information may include part information regarding a part necessary for maintenance.

With this configuration, a burden on the worker can be reduced without the need for checking the part necessary for maintenance and the number of the parts by the worker every time the alarm is issued.

(7) The numerical control device 100 according to any one of (1) to (6) may further include the part ordering unit 203 configured to output the order information regarding the order of the part based on the part information, and the display control unit 204 may display the order information.

With this configuration, the worker or the person in charge of the order can acquire the information regarding the order of the part necessary for maintenance.

(8) In the numerical control device 100 according to (7), the part ordering unit 203 may automatically order the part.

With this configuration, the part can be obtained when needed without the need for always storing parts necessary for maintenance.

(9) In the numerical control device 100A according to any one of (1) to (8), in a case where the mounted equipment has been updated and the anomaly has been sensed in the updated equipment, if the corresponding alarm information and the corresponding maintenance information are not stored in the numerical control device 100A, the information acquisition unit 202a may acquire the alarm information and the maintenance information from the server 30.

With this configuration, the maintenance information suitable for the actually-mounted equipment is displayed so that the worker can accurately perform the maintenance process.

### EXPLANATION OF REFERENCE NUMERALS

1 Control System
10(1) to 10(N) Machine Tool
11 Control Panel
100, 100A Numerical Control Device
110 Motor Drive Device
120 Control Equipment
200 Control Unit
201 Monitoring Unit
202, 202a Information Acquisition Unit
203 Part Ordering Unit
210 Display Unit
220 Storage Unit
221 Alarm Data
222 Maintenance Data
30 Server
31 Storage Unit
311 Alarm Data
312 Maintenance Data

1. A control device for controlling an industrial machine, comprising:
a monitoring unit configured to monitor the industrial machine to sense anomaly in the industrial machine;
an information acquisition unit configured to acquire alarm information regarding an alarm of the anomaly sensed by the monitoring unit and maintenance information regarding maintenance in response to the anomaly; and
a display control unit configured to display the acquired alarm information and the acquired maintenance information on a display device.

2. The control device according to claim 1, wherein the maintenance information includes at least text information and a static image for describing a maintenance process step.

3. The control device according to claim 1, wherein the maintenance information includes a URL of a maintenance website for describing the maintenance process step.

4. The control device according to claim 1, wherein the maintenance information includes a two-dimensional code for the maintenance website for describing the maintenance process step.

5. The control device according to claim 1, wherein the maintenance information includes a moving image for describing the maintenance process step.

6. The control device according to claim 1, wherein the maintenance information includes part information regarding a part necessary for the maintenance.

7. The control device according to claim 6, further comprising: a part ordering unit configured to output order information regarding an order of the part based on the part information,
wherein the display control unit displays the order information.

8. The control device according to claim 7, wherein the part ordering unit automatically orders the part.

9. The control device according to claim 1, wherein in a case where mounted equipment has been updated and the anomaly has been sensed in the updated equipment, if the alarm information and the maintenance information corresponding to the alarm are not stored in the control device, the information acquisition unit acquires the alarm information and the maintenance information from an external device.
